(19) United States
(12) Patent Application Publication
(10) Pub. No.: US 2024/0115460 A1
(43) Pub. Date: Apr. 11, 2024

(54) SYSTEM AND METHOD FOR STIMULATING AND APPLYING PRESSURE TO POINTS ON A HUMAN BODY

(71) Applicant: Propio Poynts, LLC, Chicago, IL (US)

(72) Inventors: David Peter Harris, Albuquerque, NM (US); Emily Farnham Blair, Albuquerque, NM (US)

(21) Appl. No.: 17/961,399

(22) Filed: Oct. 6, 2022

(51) Int. Cl. A61H 39/04

(52) U.S. Cl. CPC A61H 39/04; A61H 2201/0119; A61H 2201/0157; A61H 2201/1695

(57) ABSTRACT

A system for providing a sustained, continuous pressure to a point on the body is provided. The system can include a stimulating projection in the form of a small molded piece that is secured to a point on a human body by an adhesive pad or tape. In another form the stimulating projection can include a clip on one side. The clip can be attached to a strap or garment worn on the body to keep the stimulating projection in place.

### CROSS-REFERENCE TO RELATED APPLICATIONS

None.

### FEDERALLY SPONSORED RESEARCH OR DEVELOPMENT

N/A

### FIELD OF THE INVENTION

The present invention is generally directed to a system or method for applying sustained stimulation or pressure to points on a human body, and more particularly, to a system or method which includes applying a stimulating projection to a point on the body with an adhesive tape or pad, or clipping the projection to a strap or garment to provide continuous stimulation or pressure.

### DESCRIPTION OF THE PRIOR ART

There are a number of locations (spots) on the human body that can be stimulated for therapeutic effect and/or proprioceptive feedback. These spots include universal locations such as acupressure points or reflexology points, and in addition, transitory locations such as those identified as myofascial pain points (e.g., muscle knots) as well as any spot that brings more information to the somatosensory map.

A multitude of therapeutic approaches utilize this knowledge. These include hands-on massage and the use of tools including handheld devices, such as balls, rollers, sticks and power tools, such as percussion devices. Some of these approaches may provide limited attachment to the body.

While the various techniques used to resolve muscle pain, poor posture, and so on, can be very effective in the short term when practiced by a skilled therapist, they all suffer from the same problem that the therapeutic effect is transitory, and relief may be short termed. The present invention provides a sustainable, ongoing therapy that can be applied to a human body and held in place indefinitely without requiring a therapist present throughout its entire use.

### SUMMARY OF THE INVENTION

The present invention provides a solution for ongoing, and varying levels of stimulation of the aforementioned spots by providing a range of objects which can be precisely attached to spots on the body in a variety of ways, such as adhesive tape, or held in place by clips attached to belts, straps, or other clothing, to provide light but continuous pressure for extended periods of time. The invention can be used to enhance prior clinical treatment, or provide self-administered relief, body awareness, proprioception, and improved posture. The objects can be formed with a variety of convex surfaces and configurations, in materials of various levels of hardness. They can be manufactured in multiple materials such as plastics, rubber, metals and organic materials,

In accordance with one aspect of the invention, a system for providing sustained stimulation to a point on a human body is provided. The system comprises a pad having a first side and a second side, with an adhesive on the second side of the pad. A stimulating projection is connected to a portion of the second side of the pad. Adhering the pad to a human body forces the stimulating projection to press against a portion of the body.

The stimulating projection can include a flat lower surface for connection to the pad. The projection can be in a variety of shapes. For example, the stimulating projection can include an X-shaped flange or a V-shaped flange extending upward from the flat lower surface. Alternatively, the stimulating projection can include a domed shape and/or a plurality of ribs or other flanges extending therefrom.

The stimulating projections can be formed from plastic, rubber, metal or other similar materials. The projections can be a single piece of material, or have multiple components. They can be formed to have varying degrees of flexibility or hardness as needed for a particular therapeutic use.

The pad can be formed from kinesiology tape or other similar materials. The pad can be circular with the stimulating projection positioned in a center portion. However, other shapes can be utilized. A cover material can be placed over the adhesive on the second side of the pad until the pad is applied to a body. The pad is applied such that the stimulating projection is positioned on an acupressure point or a muscle knot on the body.

In accordance with another aspect of the invention, a clip on system for applying sustained stimulation to a point on a body is provided. The system comprises a stimulating projection having a first contacting side for contacting a portion of a human body, and a second side having a clip for connection to an article for maintaining the projection's position on the body.

The article can be a strap configured to span around a portion of a body. The stimulating projection is connected to the strap by the clip. Alternatively, the article can be a garment configured to be wearable on a body. The stimulating projection is connected to the garment by the clip.

The contacting portion of the stimulating projection can include a ridge extending away from the second side for contacting the body. In one instance, the contacting portion can be asymmetrical.

The stimulating projection with a clip can be formed from plastic, rubber, metal or other similar material. The contacting side and the clip can be formed as a single, integral piece of material. Alternatively, the clip can be removable—in this aspect, different sized or shaped clips can be connected to the body contacting side as needed for particular position on the body or article required.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings and attachments in which:

FIGS. 1(a)-1(f) are perspective views of a variety of stimulating projections with multiple protuberances in accordance with an aspect of a system of the present invention;

FIG. 2 is a perspective view of the stimulating projection of 1(c) on a surface of a flexible adhesive pad in accordance with an aspect of the system of the present invention;

FIGS. 3(a)-3(b) are perspective views of a stimulating projection having an asymmetric convex domed shape integral with a clip in accordance with another aspect of a system of the present invention;

FIG. 4 is a perspective view of the system of FIG. 2 applied to a difficult to reach pressure point on a human body;

FIG. 5 is a perspective view of the system of FIGS. 3(a)-3(b) applied to pressure points on either side of a lower spine on a human body;

FIG. 6 are diagrams of the front, back and sides of a human body showing the system of FIG. 2 applied to various locations; and,

FIG. 7 are diagrams of the front and back of a human body showing the clips of FIGS. 3(a) and 3(b) applied to various locations with straps.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides systems that can be utilized to stimulate, apply pressure and/or massage points on a human body for therapeutic effect. The systems can be applied to the body and thus sustain the therapy without the need for a therapist to be present to continuously administer such therapy.

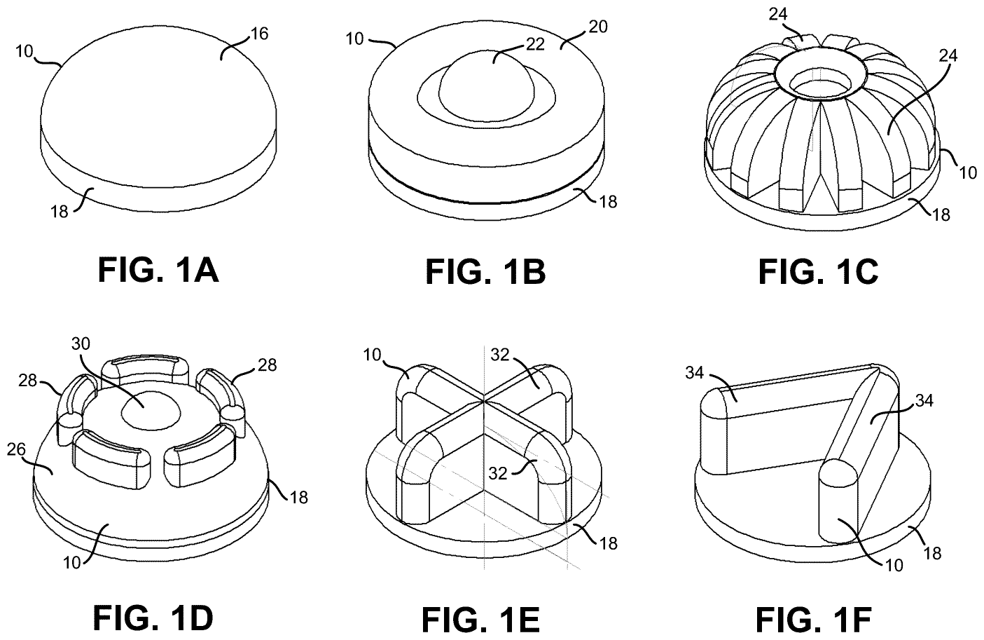

One system for providing sustained stimulation to a body is illustrated in FIGS. 1, 2, 4 and 6. The system includes a stimulating projection 10 secured to a flexible tape or pad 12 that can be applied to a body 14. The pad 12 has a first, outer surface and a second, inner surface which includes an adhesive.

The stimulating projection 10 can be a small, molded or shaped object formed from plastic, rubber, metals, organic materials or other similar materials. In some instances, the projection 10 can be formed from multiple materials. The projection 10 can also be made to have varying levels of hardness, and in some instances may include both flexible and hard elements.

The stimulating projections 10 can be formed to have a variety of shapes which can be designed for different therapeutic uses or requirements. In this regard, FIGS. 1(a)-1(f) show a number of different shapes. FIG. 1(a) provides a stimulating projection 10 having a simple rounded dome shape 16 extending upward from a flat bottom surface 18. FIG. 1(b) provides an outer ring 20 with a centrally located dome 22. FIG. 1(c) shows a plurality of flanges or ribs 24, collectively forming a domed shaped outer surface. FIG. 1(d) includes a dome 26 with additional flanges 28 and a centrally located dome shape 30 extending upward therefrom. FIG. 1(e) provides flanges 32 forming an X-shape extending upward and FIG. 1(f) includes flanges 34 forming a V-shape extending upward. In each instance, the flat bottom 18 of each projection 10 is round, however, other shapes can be used.

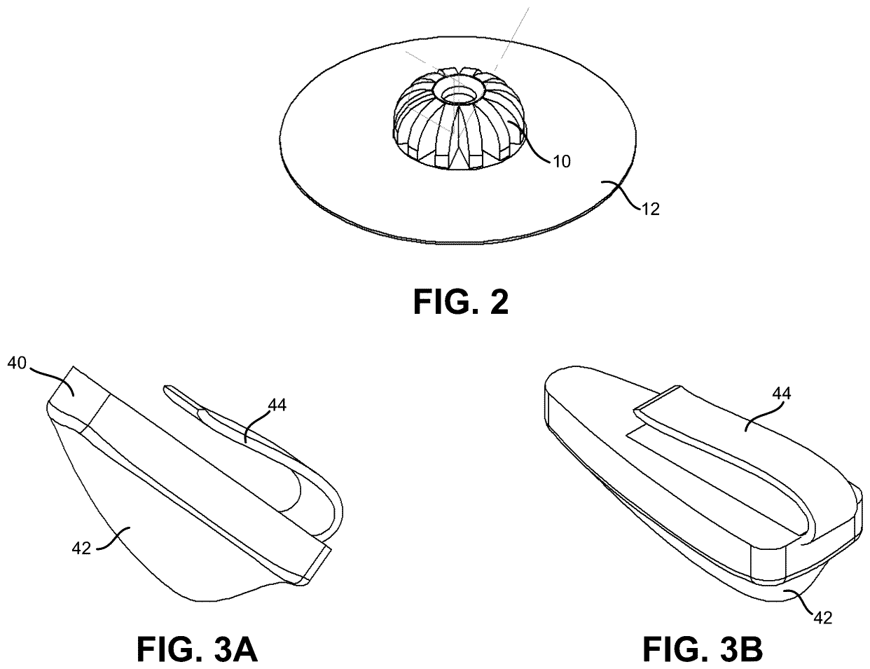

The stimulating projection 10 is connected to a central portion of the second surface of the pad 12 as exemplified in FIG. 2. Although the adhesive on the second side of the pad 12 can be used to secure the projection 10, other means of connecting the projection 10 to the pad 12 can be implemented. In one embodiment, the projection 10 can be integrally formed with the pad 12 with only providing adhesive on the portion of the pad 12 outward from the projection 10. As shown, the pad 12 is circular and the stimulating projection is positioned at the center, leaving a larger portion of the pad 12 radially outward from the projection 10 which can be used to adhere the system to a location on the body. While other shapes can be used, the circular shape enables one to more accurately place the system at the appropriate point on the body. The system is applied in a manner to ensure the projection 10 is applying a sufficient pressure to the desired location of the body. Once in place, the system can provide sustained stimulation until it is removed from the body.

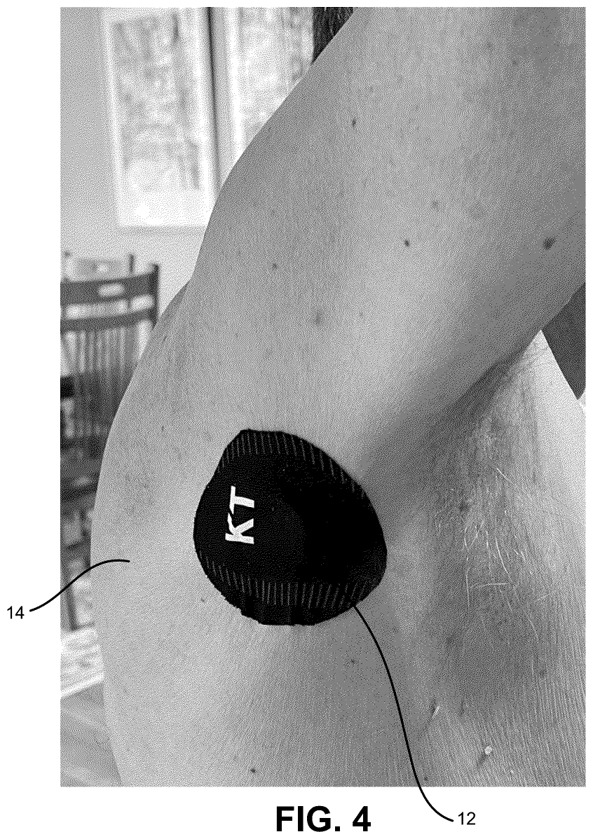

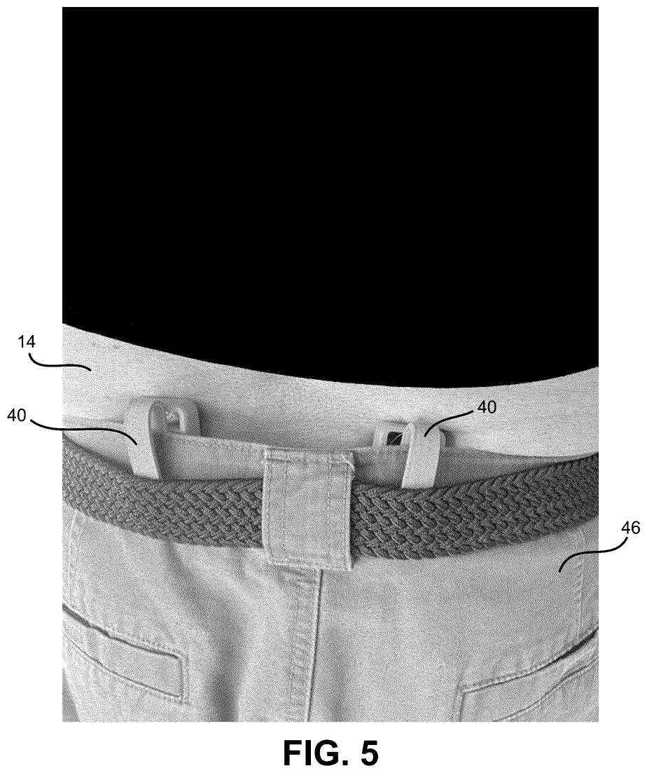

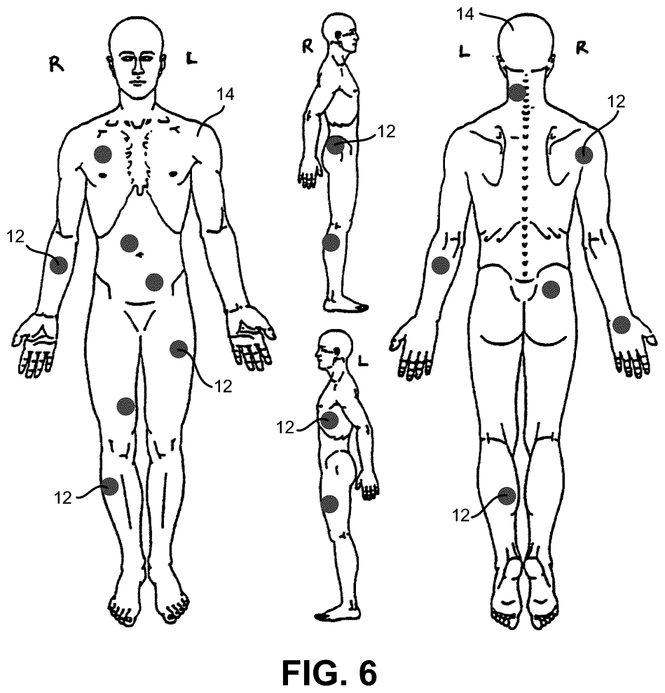

The pad 12 is preferably formed from kinesiology tape which is designed to mimic the skin's elasticity. This allows for movement of the body while keeping the system securely in place at the desired location. The system allows for applying pressure to points on the body that are difficult to reach or awkwardly placed. One example of the system is shown placed under the arm of a patient in FIG. 4. FIG. 6 provides a number of examples of the system on a body 14.

FIGS. 3, 5 and 7 show another system for stimulating, applying pressure to or massaging a portion of the body 14. In this system, a stimulating projection 40 is provided having a body contacting portion 42 on a first side, and an attaching mechanism on a second side in the form of a clip 44. The body contacting portion 42 includes a ridge like extension but can be formed having a variety of shapes. In this example, the contacting portion 42 is asymmetrical between one end of the projection 40 and the opposing end of the projection.

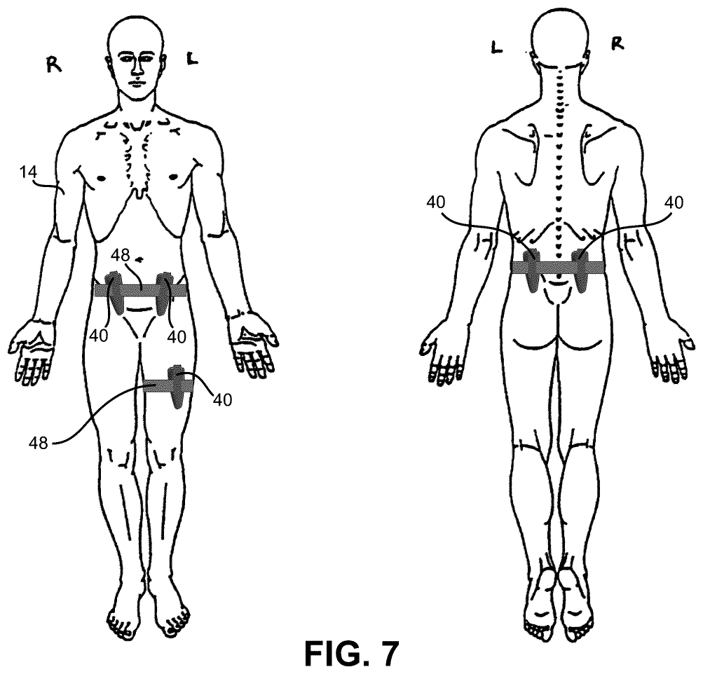

The clip 44 is used to connect the projection 40 to a garment (e.g., pants 46) as shown in FIG. 5, or a strap or belt 48 as shown in FIG. 7. The garment 46 or strap 48 can be tightened to provide sufficient pressure to the desired locations. FIG. 5 shows two projections 40 positioned on either side of a lower spine of a body 14.

Again, the projection 40 can be formed from different types of materials (e.g., plastic, rubber, metal) with varying degrees of hardness. Moreover, the projection 40 can be single, integral unit, or it may be formed with multiple pieces. In one instance, the projection can be formed with a removable clip feature and then be used with a pad 12 in a similar manner as the system described above.

The pad 12 can include a separate backing covering the adhesive prior to use.

Many modifications and variations of the present invention are possible in light of the above teachings. It is, therefore, to be understood within the scope of the appended claims the invention may be protected otherwise than as specifically described.

We claim:

1. A system for providing sustained stimulation to a point on a human body comprising:
a pad having a first side and a second side;
an adhesive on the second side of the pad; and,
a stimulating projection connected to a portion of the second side of the pad wherein adhering the pad to a human body forces the stimulating projection to press against a portion of the body.

2. The system of claim 1 wherein the stimulating projection has a flat lower surface for connection to the pad.

3. The system of claim 2 wherein the stimulating projection includes an X-shaped flange extending upward from the flat lower surface.

4. The system of claim 2 wherein the stimulating projection includes a V-shaped flange extending upward from the flat lower surface.

5. The system of claim 2 wherein the stimulating projection includes a domed shaped flange extending upward from the flat lower surface.

6. The system of claim 2 wherein the stimulating projection includes a plurality of flanges extending upward from the flat lower surface.

7. The system of claim 1 wherein the pad is formed from kinesiology tape.

8. The system of claim 1 wherein the stimulating projection is plastic.

9. The system of claim 1 wherein the stimulating projection is rubber.

10. The system of claim 1 wherein the pad is circular.

11. The system of claim 10 wherein the stimulating projection is positioned at a center location on the second side of the pad.

12. The system of claim 1 wherein the pad is adhered to a human body and the stimulating projection is positioned on an acupressure point of the body.

13. A system for applying sustained stimulation to a point on a body comprising:
a stimulating projection having:
a first contacting side for contacting a portion of a human body; and,
a second side having a clip for connection to an article for maintaining the projection's position on the body.

14. The system of claim 13 wherein the article comprises a strap configured to span around a portion of a body, wherein the stimulating projection is connected to the strap by the clip.

15. The system of claim 13 wherein the article comprises a garment configured to be wearable on a body, wherein the stimulating projection is connected to the garment by the clip.

16. The system of claim 13 wherein the contacting portion of the stimulating projection includes a ridge extending away from the second side.

17. The system of claim 16 wherein the contacting portion is asymmetrical.

18. The system of claim 13 wherein the stimulating projection is formed from plastic.

19. The system of claim 13 wherein the stimulating projection is formed from rubber.

20. The system of claim 13 wherein the contacting side and the clip are a single, integral piece of material.
